(19) United States
(12) Patent Application Publication
(10) Pub. No.: US 2017/0283971 A1
(43) Pub. Date: Oct. 5, 2017

(54) Selectively Electoplating Plastic Substrates Having a Decorative Film

(71) Applicant: Certus Automotive Incorporated, Auburn Hills, MI (US)

(72) Inventors: Timothy Scott Hondorp, Haslett, MI (US); Michael James Prokopetz, Clarkston, MI (US)

(21) Appl. No.: 15/518,691

(22) PCT Filed: Dec. 8, 2015
(86) PCT No.: PCT/US2015/064446

§ 371 Date: Apr. 12, 2017

Related U.S. Application Data
(60) Provisional application No. 62/090,131, filed on Dec. 10, 2014.

(51) Int. Cl. C25D 5/56; C25D 5/02; C25D 3/04; B44C 5/04; B44C 1/10

(52) U.S. Cl. CPC C25D 5/56; B44C 5/0415; B44C 1/10; C25D 3/04; C25D 5/022

(57) ABSTRACT

A selectively-metalized plastic part that includes a plastic substrate substantially conforming to the shape of the plastic part, a plastic film using an electroplating-resistant material that is applied to the plastic substrate, and an electroplating portion, wherein after exposing the plastic part to an electroplating process the electroplating portion receives metal plating whereas the plastic film does not.

### CLAIM OF PRIORITY

This application claims priority to U.S. Provisional Application No. 62/090,131 filed on Dec. 10, 2014 and PCT application Ser. No. PCT/US2015/064446 filed Dec. 8, 2015 the entire contents of which are hereby incorporated in their entirety.

### TECHNICAL FIELD

The present invention relates to electroplating plastic substrates and, more particularly, to electroplating plastic substrates having a plastic film.

### BACKGROUND

Plastic parts provide protective enclosures or decorative trim for a variety of applications. In one example, vehicle interiors use plastic parts on surfaces a vehicle occupant may touch or see. For instance, vehicle center consoles or interior trim of vehicle doors may use plastic parts having a particular aesthetic surface. Apart from the aesthetic surface, the plastic part can include a chrome-plated component that provides additional detail and aesthetics to the plastic part. Other applications, such as external housings of consumer electronics, can use plastic parts as well. These plastic parts are often assemblies including a plurality of separate components. The materials and process used to make one component of the plastic part may cause harm to another component of the plastic part. As a result, the components that make up the plastic part are formed separately and later joined as a finished assembly. However, plastic parts assembled from separate components suffer from increased levels of buzz, squeak, and rattle (BSR) due to the joints inherent in such an assembly. Also, the process of separately making and assembling these components adds cost and complexity to the plastic part.

### SUMMARY

According to an embodiment of the invention, a selectively-metalized plastic part includes a plastic substrate substantially conforming to the shape of the plastic part; a plastic film using an electroplating-resistant material, wherein the plastic film is applied to the plastic substrate; and an electroplating portion, wherein after exposing the plastic part to a electroplating process the electroplating portion receives metal plating whereas the plastic film does not.

According to another embodiment of the invention, a method of selectively metalizing a plastic part includes applying a plastic film that includes an electroplating-resistant material to a plastic substrate; exposing the plastic film and the plastic substrate to an electroplating process; and applying metal plating to a surface of the plastic substrate that is exposed to the electroplating process and not covered by the plastic film.

According to yet another embodiment of the invention, a method of selectively metalizing a plastic part includes applying a plastic film to a plastic substrate, wherein the plastic film and the plastic substrate both comprise a material that receives metal plating when exposed to an electroplating process; applying a liquid coating that resists electroplating to the plastic film; exposing the plastic substrate and coated plastic film to the electroplating process; and applying metal plating to a surface of the plastic substrate that is exposed to the electroplating process and not covered by the plastic film.

### BRIEF DESCRIPTION OF THE DRAWINGS

One or more embodiments of the disclosure will hereinafter be described in conjunction with the appended drawings, wherein like designations denote like elements, and wherein:

FIG. 1 depicts an exploded view of an embodiment of a plastic part;

FIG. 2 depicts an exploded view of another embodiment of a plastic part; and

FIG. 3 depicts a perspective view of the plastic part shown in FIG. 1.

### DETAILED DESCRIPTION OF THE DRAWINGS

In the past, plastic parts may have been assembled from individual plastic subparts or components each of which can be created using a different process and/or material. These plastic parts can provide an aesthetically pleasing surface yet also be durable such that they resist dents and scratches. In one specific example, an instrument panel of a vehicle can use one or more plastic parts each made from a plastic substrate to which a decorative plastic film is applied that simulates a wood grain. A separate subpart or component comprising a chrome-plated border can surround the decorative plastic film. The plastic substrate and the decorative plastic film could be formed as one component while the chrome-plated border could be formed separately as another component. After separately forming each of the components, they would then be joined together using mechanical fastening techniques, such as heat staking or deflectable tabs from one component that engage with another component. Plastic parts created and assembled in this way can suffer from higher buzz, squeak, and rattle (BSR) levels due to possible movement where the components join. Making plastic parts out of a plurality of components can also be more expensive to assemble resulting in extra part numbers, additional mass, and a higher scrap rate due to added processes.

Rather than using a plurality of components that are separately prepared before assembly, it is possible to make plastic parts having a unitary structure that includes a plastic substrate, a plastic film, and an electroplated portion. These plastic parts have a unitary structure such that they do not use separate components that exist in a finished state and are then joined using mechanical fastening techniques. Plastic parts can be initially molded as a plastic substrate from a base material, such as acrylonitrile butadiene styrene (ABS) plastic, a mixture of polycarbonate (PC) and ABS, or Nylon. The plastic film can include an electroplating-resistant material and be applied to at least a portion of the plastic substrate. After combining the plastic substrate with the plastic film, the combined unitary structure can be immersed in an electroplating bath without adverse effect to the plastic film thereby leaving electroplated metal on portions of the plastic part the film does not cover. In one implementation, the plastic film comprises an electroplating-resistant material, such that the material from which the film is formed can resist metal electroplating. One example of the electroplating-resisting material is a PC film. In another implementation, the plastic film can be made from a material similar to or the same as that of the base material, such as ABS, ABS/PC, or Nylon, and applied to the plastic substrate. An electroplating-resistant material can then be applied to a surface of the plastic film made from a base material (such as by spraying) so that a coating of the electroplating-resistant material covers the portion of the film that will not be metal plated. The coating of electroplating-resistant material applied to the plastic film made from the base material can prevent metal plating where the coating is applied. Portions of the plastic film intended to receive metal from electroplating can be masked before spraying the coating of electroplating-resistant material. Before exposure to the electroplating process, the masking can be removed.

After receiving the plastic film, the plastic substrate or an electroplating portion of the plastic part can include a surface that is not covered by the plastic film or electroplating-resistant material. This uncovered portion can be coated or plated with metal (e.g., chrome plated) when exposed to an electroplating process. The inclusion of metal- or electroplating-resistant material in the plastic film allows the plastic part to be exposed to the electroplating bath along with the plastic film. When electroplating occurs, the plastic film and its electroplating-resistant material—whether inherent to the plastic film or sprayed on—prevent the application of metal on areas of the plastic substrate where the plastic film is added. The exposed portion of the plastic substrate or electroplating portion receives the metal from the electroplating while the plastic film is unaffected by the process.

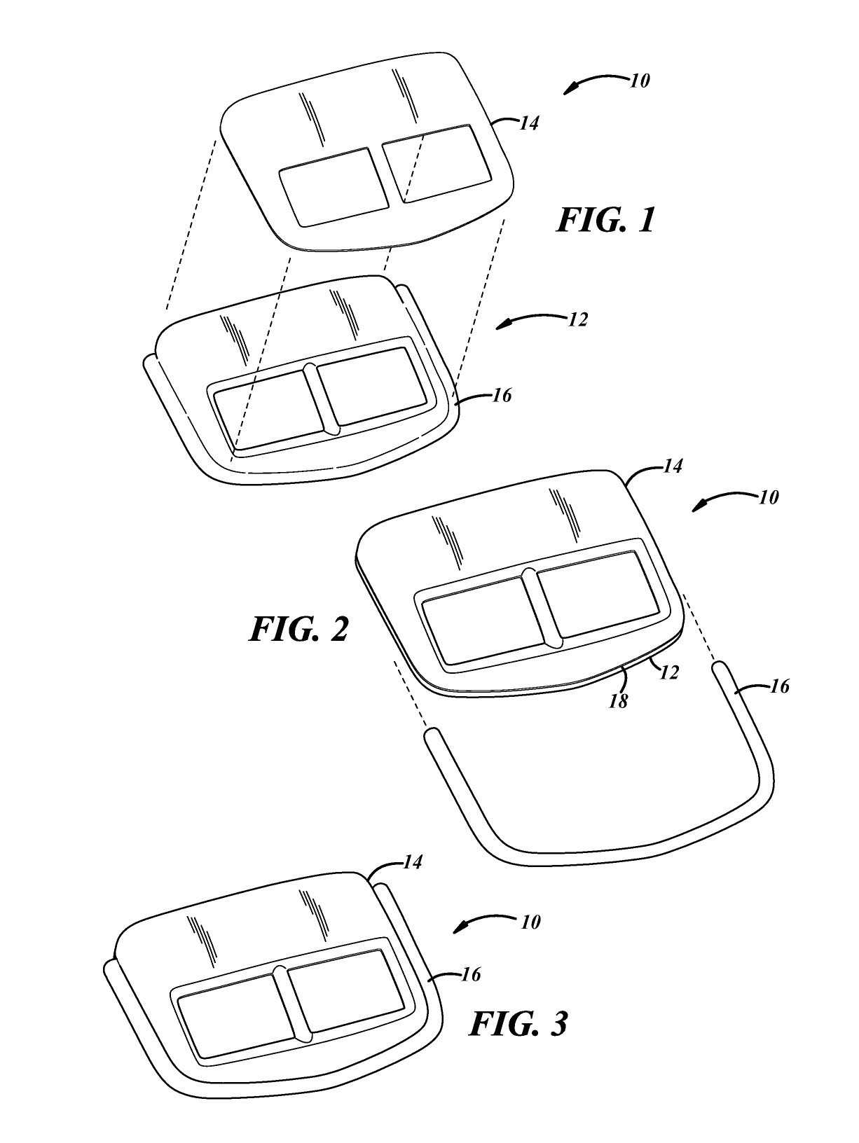

Turning to FIG. 1, an exploded view of a plastic part 10 is shown having a plastic substrate 12, a plastic film 14, and an electroplating portion 16. The plastic substrate 12 can be formed from ABS plastic, PC/ABS, or Nylon in a shape that closely conforms to the final contours of the plastic part 10 itself. The shape of the plastic substrate 12 can be created using a die or mold reflecting a desired shape of the plastic substrate 12 and formed using common plastic molding techniques, such as injection molding, vacuum molding, or thermoplastic shaping of plastic. In some applications, a trim die can be used to create the final shape of the plastic substrate 12.

A plastic film 14 can then be applied to at least a portion of the surface of the plastic substrate 12. When the plastic film 14 is partially or fully made from an electroplating-resistant material or coated with an electroplating-resistant material, the film 14 will not bond with electroplated metal when exposed to an electroplating process. In one implementation, the plastic film 14 can comprise PC or at least partially comprise PC as its electroplating-resistant material. In another implementation, the plastic film 14 can be made from ABS, ABS/PC, or Nylon and include an electroplating-resistant material that is applied in the form of a clear coat over a surface of the film 14 intended to be protected from electroplating. The clear coat material can originally exist in a liquid state and when applied to a surface of the plastic film dry to form a transparent resilient coating that prevents metal plating when exposed to an electroplating bath. One example of the electroplating-resistant material that can be applied to the plastic film 14 made from a base material is the UVT200 series ultraviolet (UV) curable SRC Hardcoat made by Redspot™. Metal plating baths or electroplating baths are known to those skilled in the art and commonly include a tank filled with an electroplating solution, such as CrO3 for chrome plating. An anode and cathode are submerged in the electroplating solution and receive an electrical charge when the plastic part 10 is immersed in the solution. In the presence of the charge, metal coats and bonds to the electroplating portion 16 of the plastic part 10.

The decorative or surface quality properties of the plastic film 14 using the electroplating-resistant material are not diminished by the electroplating process. For example, the plastic film 14 can depict a wood-grain pattern beneath a high-gloss finish on a surface that is exposed to the electroplating process. The surface quality of the high-gloss finish is such that it would be acceptable for installation in a vehicle both before and after its exposure to the electroplating process. In other words, the plastic film 14 can be exposed to the electroplating process without it receiving the metal in the electrolysis bath or marring the appearance of the plastic film 14. While the plastic film 14 is described as having a decorative appearance, it is also possible for the film to lack such a decorative element. For instance, the plastic film 14 could be substantially transparent. In addition to the simulated wood grain described above, the plastic film 14 can exhibit a wide variety of colors, patterns, and surface textures. In one embodiment, the plastic film 14 can be intended to mimic the surface of a black piano. In that case, the plastic film 14 can use a solid color (black), no pattern, and a high-gloss finish. Other combinations are possible. For example, a plastic film 14 can have a gray woven appearance that mimics carbon fiber. So it could be gray, have a woven pattern, and a high-gloss or matte surface texture. The plastic film 14 can be made from PC, a mixture of ABS and PC, or a PC equivalent film. Or the plastic film 14 can be coated with a electroplating-resistant material as described above. Various mechanisms can be used to apply the plastic film 14 to the plastic substrate 12, such as in-mold decoration (IMD) and vacuum forming.

Turning to FIG. 2, an embodiment is shown in which the plastic film 14 can be applied to the entire surface of the plastic substrate 12. The combined plastic substrate 12 and plastic film 14 may then be placed in a mold in which the electroplating portion 16 is formed from an injected resin that chemically bonds and joins to an outer edge 18 of the plastic substrate 12/plastic film 14 to form the plastic part 10 as a unitary structure. The resulting plastic part 10 comprising the plastic substrate 12, the plastic film 14, and the electroplating portion 16 can be exposed together to an electroplating process, which selectively deposits metal on the electroplating portion 16 while leaving the plastic film 14 without metal.

It should be appreciated that other embodiments are possible as well. For example, in another embodiment the electroplating portion 16 can be injected into a mold before it is attached to the plastic substrate 12/plastic film 14. After the electroplating portion 16 is formed and attached, the plastic film 14 can be vacuum formed to the plastic substrate 12 thereby creating the plastic part 10 shown in FIG. 3. The plastic part 10 shown in FIG. 3 is designed to be installed inside a vehicle but it should be appreciated that the processes and techniques discussed could be applied to non-vehicular applications as well.

It is to be understood that the foregoing is a description of one or more embodiments of the invention. However, the invention is not limited to the particular embodiment(s) disclosed herein. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A selectively-metalized plastic part, comprising:
an opaque plastic substrate substantially conforming to the shape of the plastic part;
a plastic film using an electroplating-resistant material, wherein the opaque plastic film is applied to the plastic substrate; and
an electroplating portion, wherein after exposing the plastic part to an electroplating process the electroplating portion receives metal plating whereas the opaque plastic film does not.

2. The selectively-metalized plastic part of claim 1, wherein the opaque plastic film comprises the electroplating-resistant material.

3. The selectively-metalized plastic part of claim 1, wherein the electroplating-resistant material is applied to a surface of the opaque plastic film.

4. The selectively-metalized plastic part of claim 1, wherein the electroplating-resistant material further comprises polycarbonate (PC).

5. The selectively-metalized plastic part of claim 1, further comprising a decorative image on the opaque plastic film.

6. The selectively-metalized plastic part of claim 5, wherein the decorative image further comprises a wood grain image.

7. The selectively-metalized plastic part of claim 1, wherein the opaque plastic film is applied to the plastic substrate under force created by a vacuum.

8. A method of selectively metalizing a part, comprising the steps of:
(a) applying an opaque plastic film that includes an electroplating-resistant material to a plastic substrate;
(b) exposing the opaque plastic film and the plastic substrate to an electroplating process; and
(c) applying metal plating to a surface of the plastic substrate that is exposed to the electroplating process and not covered by the opaque plastic film in response to step (b).

9. The method of claim 8, wherein the opaque plastic film comprises the electroplating-resistant material.

10. The method of claim 8, further comprising the step of applying the electroplating-resistant material to a surface of the opaque plastic film.

11. The method of claim 8, wherein the electroplating-resistant material further comprises polycarbonate (PC).

12. The method of claim 8, wherein the opaque plastic film further comprises a decorative image.

13. The method of claim 12, wherein the decorative image further comprises an image of wood grain.

14. A method of selectively metalizing a part, comprising the steps of:
(a) applying an opaque plastic film to a plastic substrate, wherein the opaque plastic film and the plastic substrate both comprise a material that receives metal plating when exposed to an electroplating process;
(b) applying a liquid coating that resists electroplating to the opaque plastic film;
(c) exposing the plastic substrate and coated opaque plastic film to the electroplating process; and
(d) applying metal plating to a surface of the plastic substrate that is exposed to the electroplating process and not covered by the opaque plastic film.

15. The method of claim 14, wherein the liquid coating further comprises polycarbonate (PC).

16. The method of claim 14, wherein the opaque plastic film further comprises a decorative image.

17. The method of claim 14, wherein the decorative image further comprises an image of wood grain.
